(19) United States
(12) Patent Application Publication
(10) Pub. No.: US 2019/0138036 A1
(43) Pub. Date: May 9, 2019

(54) Valve for Opening and Closing a Line System

(71) Applicant: Kendrion (Villingen) GmbH, Villingen-Schwenningen (DE)

(72) Inventors: Martin Ohnmacht, Fluorn-Winzeln (DE); Wolfram Maiwald, Obereschach (DE); Wolfgang Bürk, Villingen-Schwenningen (DE); Stefan Barth, Donaueschingen (DE)

(73) Assignee: Kendrion (Villingen) GmbH, Villingen-Schwenningen (DE)

(21) Appl. No.: 16/091,476

(22) PCT Filed: Apr. 7, 2017
(86) PCT No.: PCT/EP2017/058466

§ 371 Date: Oct. 4, 2018

(30) Foreign Application Priority Data
Apr. 22, 2016 (DE) 10 2016 107 474.8

(51) Int. Cl. G05D 16/10

(52) U.S. Cl. CPC G05D 16/107; F16K 31/0655

(57) ABSTRACT

A valve for closing and opening a line system, comprising a valve body which forms a valve seat; a line system with a supply line for supplying a fluid to the valve seat and with a discharge line for discharging the fluid from the valve seat, wherein the fluid is under a supply pressure in the supply line and under a working pressure in the discharge line; a closing element that releases a throttle cross-section between the valve seat and the closing element; a restoring element which applies a restoring force to the closing element; and a pressure chamber in which the fluid is under a closing pressure with which the fluid applies a closing force to the closing element to close the line system.

The present invention relates to a valve for opening and closing a line system.

Valves comprise in general a stationary valve seat with which the line system can be opened and closed, in that a movable closing element cooperates with the valve seat. Such line systems comprise a supply line for supplying a fluid to the valve seat and a removal line for removing the fluid from the valve seat, wherein the fluid in the supply line stands under a supply pressure and in the removal line under a useful pressure. Some applications require that the valve is closed as long as the supply pressure is below a certain threshold value and the valve opens as soon as the supply pressure exceeds the threshold value.

This quality can be basically carried out with the aid of adjustment devices which appropriately move the closing element when the threshold value is exceeded or dropped below. For example, electromagnetic valves can be used for this. However, it is necessary here to provide a pressure sensor which communicates with a control unit which for its part appropriately actuates the adjustment device. In addition to the expenses which these components bring about, the cabling expense and the required structural space, such electromagnetic valves have in particular the disadvantage that their functionality depends on a suitable current supply. However, the current supply is not always given, in particular in electrically autonomous systems such as vehicles. In addition, the current consumption associated with the actuation of the electromagnetic valves has a noticeable negative effect on the fuel consumption of the particular vehicle operated with an internal combustion engine. The range is reduced in electric vehicles due to the elevated current consumption.

In order to counteract these disadvantages, fluid-controlled valves are used. Such valves comprise a return element which presses against the valve seat. As long as the supply pressure of the fluid is below the threshold value, the valve remains closed so that it is a so-called “normally closed” valve. The valve is designed in such a manner that based on the supply pressure, a fluid force is applied onto the closing element which counteracts the return force. If the supply pressure rises above the threshold value, the fluid force then overcomes the return force, as a result of which the closing element is moved away from the valve seat and the valve is opened.

In order to make the return elements as small as possible and to therefore save structural space, some valves comprise a pressure chamber which is arranged, viewed from the valve seat, behind the closing element. The pressure chamber is filled with a fluid which stands under a certain pressure. The pressure brings about a closing force which acts in the same direction as the return force of the return element, as a result of which the return element is supported against the valve seat during the pressing of the closing element. Therefore, in the following the pressure of the fluid in the pressure chamber is also designated as the closing pressure. In many cases the pressure chamber is fluidically connected to the supply line so that the closing pressure is exactly as great as the supply pressure. As the supply pressure rises, the closing pressure also rises, which has the consequence that the closing pressure is moved only relatively slowly away from the valve seat and consequently the throttle cross section between the valve and the closing element, that is, the cross-sectional flow area to be traversed by the fluid when flowing from the supply line into the removal line, rises only relatively slowly with an increasing supply pressure. The closing element and the valve seat therefore act as a throttle so that the supply pressure is throttled when flowing through the throttle cross section to the useful pressure. The throttling becomes stronger, the smaller the throttle cross section is. Due to the closing element slowly moving away from the valve, the supply pressure is throttled relatively strongly to the useful pressure over a relatively large pressure range, which is disadvantageous in as far as that a high useful pressure is desired for many applications.

Therefore, an embodiment of the present invention has the problem of further developing the fluid-controlled valve of the initially described type in such a manner that the supply pressure is throttled less strongly in comparison to known fluid-controlled valves during and after the opening of the valve and consequently a higher useful pressure is present. In other words, the opening behavior should be improved in a corresponding manner so that at a given supply pressure, a greater throttle cross section is freed in comparison to known fluid-controlled valves and therefore the supply pressure becomes less strong.

This problem is solved with the features given in the claims 1, 12 and 13. Advantageous embodiment form subject matter of the subclaims.

An embodiment of the invention relates to a valve body which forms a valve seat, to a line system with a supply line for supplying a fluid to the valve seat and a removal line for removing the fluid from the valve seat, wherein the fluid in the supply line stands under a supply pressure and in the removal line under a useful pressure, to a closing element which cooperates with the valve seat for opening and closing the line system, wherein the closing element frees a throttle cross section between the valve seat and the closing element, to a return element which applies a return force onto the closing element which presses the closing element against the valve seat for closing the line system, to a pressure chamber in which the fluid stands under a closing pressure with which the fluid applies a closing force on the closing element for closing the line system, wherein the valve comprises means with which the closing pressure in the pressure chamber can be lowered below the supply pressure as a function of the freed throttle cross section.

As previously mentioned, the fluid -controlled valves known from the prior art open relatively slowly since the closing pressure is exactly as great as the supply pressure. Since the closing force applied by the closing pressure counteracts the force which the fluid applies onto the closing element, the fluid must work against the closing pressure. In contrast to this, the suggested means makes it possible to lower the closing pressure below the supply pressure as a function of the freed throttle cross section. As a consequence, the force necessary to move the closing element away from the valve seat drops. This brings it about that the valve is open more strongly at a given pressure above the threshold value in comparison to traditional valves. The stronger opening has the effect that the supply pressure is throttled less strongly when it flows through the throttle cross section.

Consequently, the useful pressure is reduced less strongly, which is advantageous in particular in applications in which a high useful pressure is needed.

In another embodiment the means can comprise a conduit which runs through the closing element and empties into the supply line, which conduit communicates with the pressure chamber. Conduits can be manufactured relatively simply in general in order to connect the pressure chamber fluidically in particular to the supply conduit. In addition, fluid controlled valves known from the prior art already comprise conduits which can be utilized at least in part. To this extent, the additional technical manufacturing expense for making the means available is comparatively low.

According to a further development of an embodiment the valve comprises a bypass which comprises the conduit running through the closing element and emptying into the supply line and comprises an annular slot surrounding the closing element and emptying into the removal line. The fluid-controlled valves known from the prior art comprise a bypass which connects the supply line to the removal line, circumventing the valve seat. The pressure chamber is arranged here between the conduit and the annular slot. Here too, the additional expense for making the means available is comparatively low.

In another embodiment the means comprises an insertion element which forms, together with the closing element, at least a part of the conduit in the area of the throttle cross section. In this embodiment it is possible to readily run the conduit into the area of the throttle cross section. Due to the above-described throttling, the static pressure in the throttle cross section drops. The insertion element is designed in such a manner that the conduit empties in the area of the throttle cross section into the supply conduit. The reduced static pressure is therefore taken off similar to a Venturi tube. Since the pressure chamber is fluidically connected via the conduit to the supply conduit, due to the fact that the conduit empties in the area of the throttle cross section into the supply conduit, the supply pressure is not present in the pressure chamber but rather the reduced static pressure is, so that the closing pressure drops. The static pressure becomes less, the less the freed throttle cross section is, which is the case at the beginning of the opening of the valve. Consequently, at the beginning of the opening of the valve, the closing pressure and the closing force resulting from it are especially low so that the valve opens more rapidly in comparison to known fluid-controlled valves. It follows from this that in the case of a given supply pressure above the threshold value, a useful pressure which is elevated in comparison to known fluid-controlled valves is available. Furthermore, the valves can be manufactured in a relatively simple manner using the insertion element without additional boreholes, lines or other construction elements having to be provided.

A further development of an embodiment is characterized in that the closing element comprises a cylindrical recess in which the insertion element is arranged. In many instances, closing elements of fluid-controlled valves known from the prior art comprise a cylindrical recess, so that there is the possibility of arranging the insertion element there. On the one hand, the conduits can be made available in an especially simple manner on account of this arrangement and on the other hand no additional structural space is required for housing the insertion element in the valve.

According to another embodiment, the insertion element has a U-shaped cross section with a first leg running substantially vertically to the longitudinal axis and a second leg running substantially parallel to the longitudinal axis. Instead of the U-shaped cross section, the insertion element could also be designed in the shape of a disk. The U-shaped cross section has, however, the advantage that the surface on which there is already an elevated flow speed and therefore a reduced static pressure prevails, is reduced. This pressure reduction otherwise brings about a force on the insertion element in the closing direction which is not desired. In addition, material can be saved with the U-shaped cross section.

Furthermore, the insertion element can comprise a first front surface which faces the closing element and on which a number of recesses are arranged. The recesses form a part of the conduit and fluid flows through them. The recesses make it possible to connect the insertion element directly to the closing element without having to provide fastening projections or spacers. This simplifies the manner how the insertion element is fastened to the closing element.

The opportunity is presented that the insertion element forms a second front surface on the free end of the second leg which comprises a bevel facing the longitudinal axis. The providing of a bevel on the free end of the second leg has the result that the insertion element runs in a relatively pointed manner in the area of the throttle cross section. This brings about a second throttling and consequently a pre-throttling, as a result of which the closing pressure in the pressure chamber is especially sharply lowered and the opening behavior of the valve can be further improved. It should be mentioned here that a strong throttling also brings about a strong reduction of the useful pressure, which is opposed, on the first glance, to the goal of the present invention. However, the throttling decreases with an increasing distance of the closing element from the valve seat. Consequently, the lowering of the useful pressure only lasts a relatively short time and is re-compensated with an increasing distance of the closing element from the valve seat and is overcompensated after a certain distance.

A further development of an embodiment is characterized in that the insertion element can move relative to the closing element. As a result thereof, the throttle cross section can be varied as a function of the existing supply pressure so that an especially good throttling can be made available directly after the opening of the valve. As previously mentioned, an especially effective throttling brings about a strong lowering of the closing pressure in the pressure chamber. The stronger the closing pressure in the pressure chamber can be lowered, the better the opening behavior becomes. This can be achieved in that the distance between the front surface of the insertion element and between the closing surface of the closing element is reduced in the open state. In this manner the overflow cross section of the pre-throttling is reduced, which increases the speed and reduces the static pressure, which, for its part lowers the return force generated by the pressure chamber. The appropriate maximum here is approximately at the point at which the pre-throttling becomes the main throttle (distance front surface—closing surface approximately 0 mm).

Another embodiment is characterized in that the insertion element is fastened by a number of springs on the closing element. The use of springs makes it possible to readily define the movement of the insertion element relative to the closing element, for example, in that springs with a certain characteristic curve are used. It can be determined with the selection of the characteristic curve how far the insertion element shifts at a certain supply pressure relative to the closing element.

In a further development of an embodiment the valve comprises an adjustment device for moving the closing element along the longitudinal axis. As has already been mentioned multiple times, the present invention relates to a fluid-controlled valve which does not need a separate adjustment device. However, a plurality of fluid-controlled valves known from the prior art comprise an adjustment device which is known and consists of electromagnetic valves, and comprise an armature, a pole shoe and a spool. This adjustment device can be used as a redundancy in order to be sure that the fluid-controlled valve can be closed under all conditions. This increases the operational safety of the present valve.

An embodiment of the invention relates to a vehicle which comprises a valve according to one of the previous claims. The technical effects and advantages which can be achieved with the suggested vehicle correspond to those which were discussed for the suggested valve. In sum, it is pointed out that it is possible with the present valve to make a good opening behavior available so that the useful pressure is higher, in comparison to known fluid-controlled valves, at a certain supply pressure located above the threshold value. For example, a higher useful pressure can be advantageously used under the following conditions: in the case of vehicles, the engine oil can be used to cool the piston head of an internal combustion engine. However, a cooling of the piston head is only necessary when the internal combustion engine is being operated above a certain suction load. For example, after the start, in particular after a cold start and at a standstill of the vehicle, a cooling of the piston head is generally not required.

An opening of the present valve can be used to utilize the useful pressure for loading a nozzle with which engine oil is sprayed against the piston head, which is consequently cooled.

An implementation of the present invention relates to a method for operating a valve for opening and closing a line system, wherein the valve comprises

A valve body which forms a valve seat,

A line system with a supply line for supplying fluid to the valve seat and a removal line for removing the fluid from the valve seat, wherein the fluid in the supply line stands under a supply pressure and in the removal line under a useful pressure,

A closing element which cooperates with the valve seat for opening and closing the line system,

A return element which applies a return force on the closing element which presses the closing element against the valve seat (26) for closing the line system, and

A pressure chamber in which the fluid stands under a closing pressure with which the fluid applies a closing force on the closing element for closing the line system, wherein the method comprises the following steps:

The freeing of a throttle cross section between the valve seat and the closing element when the supply pressure exceeds a given threshold value, and

A lowering of the closing pressure in the pressure chamber below the supply pressure with appropriately designed means.

The technical effects and advantages which can be achieved with the suggested method correspond to those which were discussed for the suggested valve. In sum, it is pointed out that it is possible with the present valve to make a good opening behavior available so that the useful pressure is higher, in comparison to known fluid-controlled valves, at a certain supply pressure located above the threshold value.

An embodiment of the invention relates to the using of a valve according to one of the previously explained embodiments for applications in the automotive field and in particular for cooling piston heads. The technical effects and advantages which can be achieved with the suggested application correspond to those which were discussed for the suggested valve. In sum, it is pointed out that it is possible with the present valve to make a good opening behavior available so that the useful pressure is higher, in comparison to known fluid-controlled valves, at a certain supply pressure located above the threshold value.

Exemplary embodiments of the invention are explained in detail in the following with reference made to the attached drawings. In the drawings,

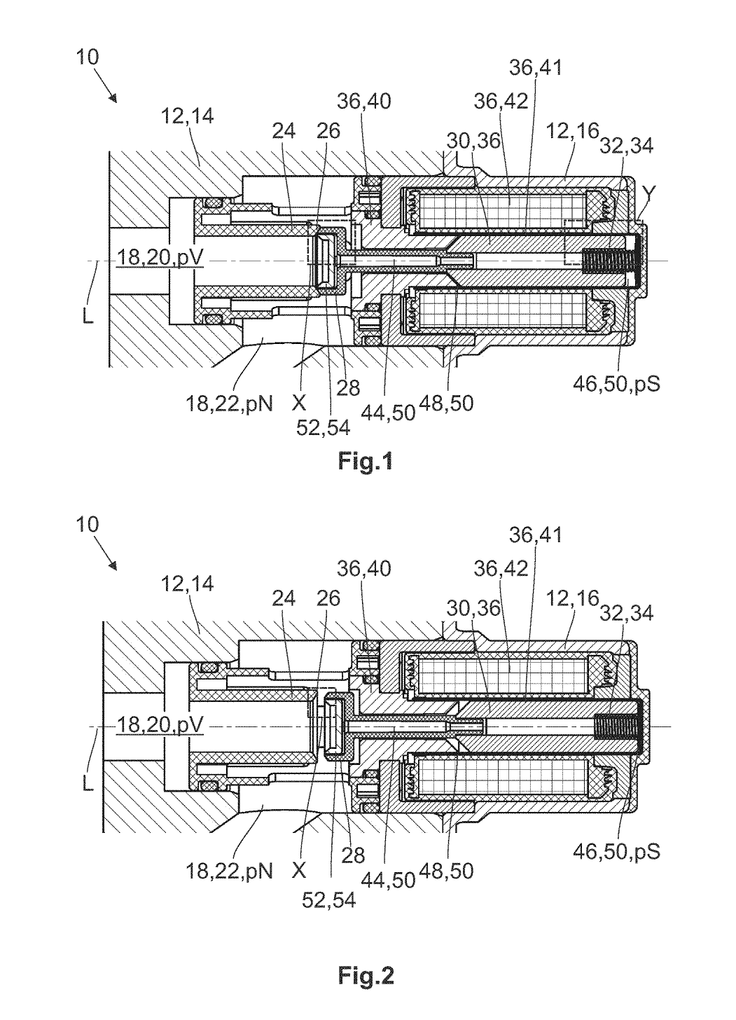

FIG. 1 shows a sectional view through an exemplary embodiment of a fluid-controlled valve according to the invention in the closed state,

FIG. 2 shows the valve shown in FIG. 1 in the open state,

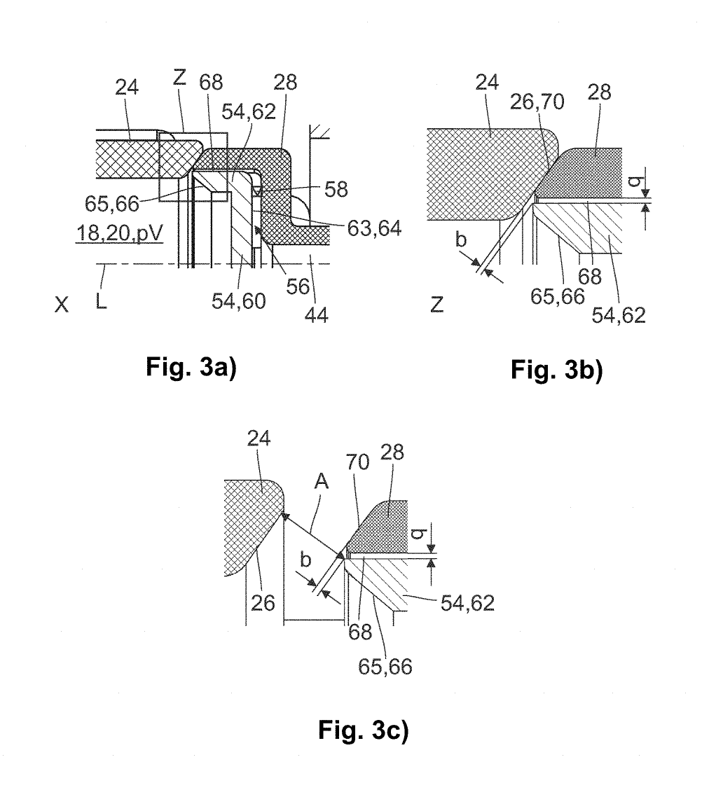

FIG. 3a) shows an enlarged view of the area X characterized in FIG. 1,

FIG. 3b) shows an enlarged view of the area Z characterized in FIG. 3a),

FIG. 3c) shows an enlarged view similar to FIG. 3b), wherein, however, the valve is in the open state according to FIG. 2,

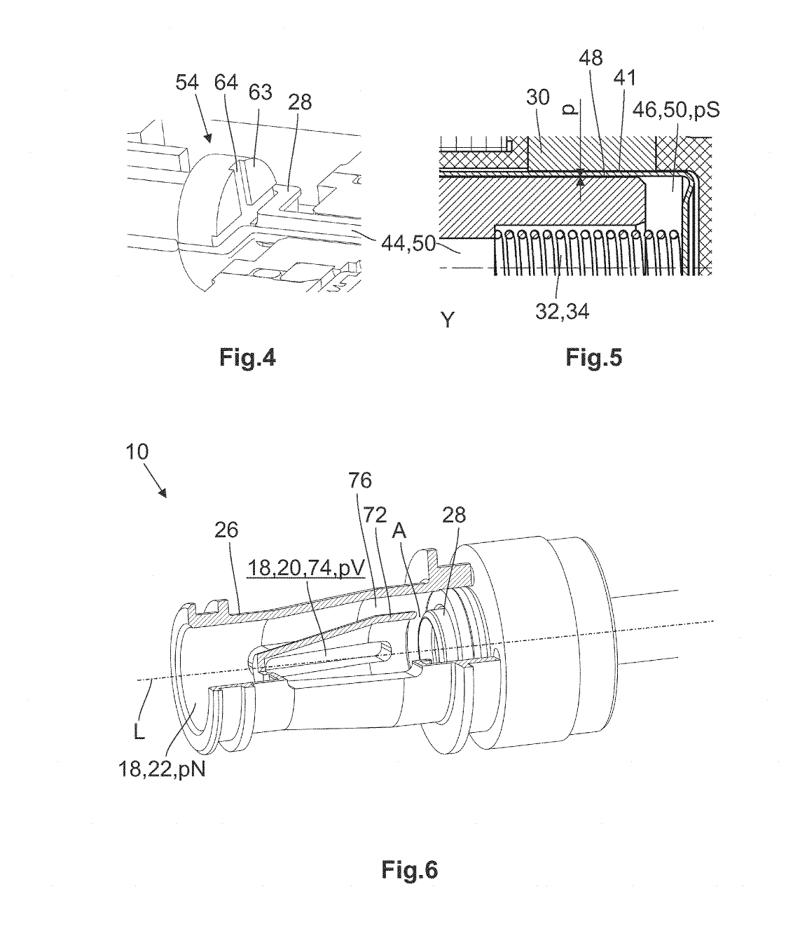

FIG. 4 shows a perspective view of an insertion element,

FIG. 5 shows an enlarged view of the area Y characterized in FIG. 1, and

FIG. 6 shows a perspective view of a part of another exemplary embodiment of the fluid-controlled valve according to the invention.

FIG. 1 shows an exemplary embodiment of a fluid-controlled valve 10 according to the invention using a sectional view. The valve 10 comprises a housing 12 with a first housing part 14 and a second housing part 16, wherein a line system 18 is arranged in the first housing part 14, and which comprises a supply line 20 and a removal line 22. Furthermore, a valve body 24 is arranged in the first housing part 14 and forms a valve seat 26. Furthermore, the valve 10 comprises a closing element 28 which is arranged so that it can be shifted along a longitudinal axis L. The closing element 28 is connected to an armature 30 which cooperates with a return element 32, in this case with a return spring 34 which is supported on the second housing part 16. Instead of the return spring 34, a permanent magnet can also be used.

The armature 30 is part of an adjustment device 36 with which the closing element 28 can be shifted along the longitudinal axis L. The adjustment device 36 furthermore comprises a pole shoe 40 which surrounds the closing element 28, and comprises a casing 41 which surrounds the armature 30. A coil body 42 which also belongs to the adjustment device 36 is arranged radially outside of the casing 41, which coil body can be loaded with electrical current in a manner not shown in detail, as a result of which the closing element 28 can be shifted along the longitudinal axis L. However, it should be noted at this point, as already mentioned, that the adjustment device 36 is provided mainly for closing the valve even above the opening pressure, and the closing element 28 is exclusively shifted by a fluid in the non-actuated operation which flows from the supply line 20 into the removal line 22 when the valve 10 is open.

The closing element 28 comprises a conduit 44 which runs through the middle of the closing element 28 and which continues inside the armature 30 along the longitudinal axis L. The conduit 44 empties at the end of the armature 30, viewed from the closing element 28, into a pressure chamber 46. An annular slot 48 is formed between the casing 41 and the armature 30 as well as between the closing element 28 and the pole shoe 40. The annular slot has a distance p between the armature 30 and the casing 41 (see FIG. 5), which is between 0.03 and 0.07 mm in the example shown, as a result of which a cross-sectional area of between 0.72 to 1.68 mm² is achieved. The conduit 44, the pressure chamber 46 and the annular slot 48 form a bypass 50 with which the supply line 20 and the removal line 22 are connected, circumventing the closing element 28. The annular slot 48, in particular between the casing 41 and the armature 30, is conditioned by the construction and not necessary for realizing the principle according to the invention. In so far, it is not necessary to provide a bypass 50. Only the fluid communication between the supply line 20 and the pressure chamber 46 must be given.

The fluid which flows into the supply line 20 stands under a supply pressure pV. The fluid in the removal line 22 stands under a useful pressure pN, and the fluid in the pressure chamber 46 stands under a closing pressure pS.

Furthermore, the present valve 10 comprises means 52 with which the closing pressure pS in the pressure chamber 46 can be lowered below the supply pressure pV, as will be explained in detail in the following. In the example shown, the means 52 comprises an insertion element 54 which is shown on an enlarged scale in FIG. 3a). The closing element 28 comprises on its free end, which cooperates with the valve seat 26 for closing the valve 10, a U-shaped section. Inside the U-shaped section, the closing element 28 forms a cylindrical recess 56 in which the insertion element 54 is arranged. The insertion element 54 is fastened in the example shown by a spring 58 to the closing element 28 so that it can move along the longitudinal axis L. Alternatively, the insertion element 54 can also be firmly fastened directly on the closing element 28 without the use of springs 58.

The insertion element 54 also has a U-shaped cross section, for which it comprises a first leg 60 which runs approximately vertically to the longitudinal axis L and comprises a second leg 62 which runs substantially parallel to the longitudinal axis L. It can be recognized from FIG. 4 that the insertion element 54 comprises a total of four recesses 64, running in a crossed manner on a first front surface 63 facing the closing element 28.

The insertion element 54 comprises a bevel 66 on a second front surface 65 arranged on the free end of the second leg 62, which bevel faces the longitudinal axis L (see especially FIGS. 3a) to 3c)).

The insertion element 54 is fastened in such a manner to the closing element 28 that a slot 68 running parallel to the longitudinal axis L is formed between the second leg 62 and the closing element 28. The distance q between the closing element 28 and the insertion element 54 and forming the slot 68 is between 0.07 and 0.13 mm so that a cross-sectional area of 1.78 and 3.1 mm² is made available. The recesses 64 create the fluid communication between the slot 68 and the conduit 44, which is especially apparent from FIG. 4.

The present valve 10 is operated in the following manner: In the starting state the supply pressure pV of the fluid in the supply conduit is below a certain threshold value which can be, for example, between 0.8 and 1 bar. Due to the fact that the pressure chamber 46 has a fluid communication with the supply line 20 via the slot 68 made available by the insertion element 54 and via the conduit 44, the closing pressure pS in the pressure chamber 46 is exactly as great as the supply pressure pV.

In this case, the sum of the return force applied by the return element 32 and of the closing force applied by the closing pressure pS is greater than the force acting by the closing element 28 by the fluid on account of the supply pressure. Consequently, the closing element 28 is pressed against the valve seat 26, as a result of which the valve 10 is closed. The useful pressure pN prevailing in the removal conduit is 0 bar.

Now, if the supply pressure pV rises over the threshold, the closing element 28 begins to move away from the valve seat 26. This movement results from a comparison of the FIGS. 3b) and 3c). Consequently, a throttle cross section A is freed through which fluid can flow. At the beginning of this movement of the closing element 28 away from the valve seat 26, the throttle cross section A is very small, so that the closing element 28 and the valve seat 26 together have the effect of a throttle. Based on the small throttle cross section 8, the flow rate of the fluid from the supply line 20 into the removal line 22 is relatively great. As a consequence thereof, the static pressure drops in the area between the valve seat 26 and the closing element 28. Furthermore, the supply pressure pV is throttled to the useful pressure pN.

As is especially apparent from the FIGS. 3b) and 3c), the slot 68 empties in the area of the throttle cross section A into the supply line 20. This brings it about that the reduced backup pressure is transferred via the slot 68 and via the conduit 44 into the pressure chamber 46 so that the closing pressure pS drops. This has the result for its part that the closing force applied from the pressure chamber 46 onto the closing element 28 also drops and at a given supply pressure pV, the closing element 28 can be moved further against the return element 32 away from the valve seat 26 than is the case with known valves. Known valves do not comprise the means 52 and in particular not the insertion element 54, so that the supply pressure pV is also present in the pressure chamber 46 and cannot be lowered. In the case of the valve 10 according to the invention, the throttle cross section A is greater at a given supply pressure pV, as a result of which the throttling of the supply pressure becomes less on the useful pressure pN when flowing through the throttle cross section A. As a result, there is a higher useful pressure pN at a given supply pressure pV than in known valves.

As already explained, the insertion element 54 is fastened by the springs 58 on the closing element 28 (cf. FIG. 3a). The characteristic curves of the springs 58 are selected in such a manner that in the closed state of the valve 10, that is, when the closing element 28 rests with a closing area 70 (see FIG. 3c) on the valve seat 26, a distance b which describes the smallest distance between the insertion element 54 and the closing area 70 is not dropped below. In the example shown, the distance b is between 0.09 and 0.11 mm This ensures a pressure compensation between the supply conduit 20 and the pressure chamber 46. The same applies in an analogous manner if the insertion element 54 if firmly fastened on the closing element 28.

As was described above, in order to realize a good opening behavior, a relatively strong throttling at the beginning of the opening procedure is important to effectively lower the closing pressure pS in the pressure chamber 44, whereas later, a throttling should be avoided as far as possible in order to lower the useful pressure pN as little as possible. For the case presented, that the insertion element 54 can be moved relative to the closing element 28, the insertion element 54 is moved with an increasing supply pressure pV along the longitudinal axis L toward the closing element 28 and the springs 58 are compressed. Consequently, the distance b is enlarged so that the throttle effect coining from the insertion element 54 continues to decrease and after a certain point it becomes negligibly low. This has the result that the useful pressure pN is throttled less and less strongly as the supply pressure pV rises. In other words, the pressure drop is reduced while the stroke of the valve 10 remains the same. In addition, the distance (FIG. 3c)) can become less after the opening. Therefore, the overflow cross section of the pre-throttling is reduced, as a result of which the rate is raised and the static pressure zo reduced, which for its part lowers the return force generated by the pressure chamber. The appropriate maximum here is approximately at the point at which the pre-throttling becomes the main throttle (b approximately 0 mm) This improves the opening behavior and the stroke is increased at a given supply pressure.

The closing area 70 of the closing element 28 follows the course of the surface of a spherical segment and is therefore convexly curved. On the other hand, the valve seat 26 is largely plane. As a result thereof, a linear contact and no surface contact is produced when valve 10 is closed. The production of a linear contact has, in contrast to a surface contact, the advantage that a more secure closure of the valve 10 even when using lest strict tolerances is ensured.

FIG. 6 shows another exemplary embodiment of the fluid-controlled valve 10 according to the invention using a perspective partial view, wherein the insertion element 54 is not shown for reasons of presentation. The construction of the closing element 28 and of the insertion element 54 and their arrangement relative to one another is the same as in the exemplary embodiments shown in the FIGS. 1 to 5. In this case, however, the flow through the valve 10 is in the opposite direction. Whereas in the exemplary embodiment which is shown in the FIGS. 1 to 5 the supply line 20 exits concentrically to the longitudinal axis L and the removal line 22 exits radially from the first housing part 14, the inverse is true in the other exemplary embodiment. The supply line 20 enters radially into the first housing part 14 and the removal line 22 runs concentrically to the longitudinal axis L. In order to be able to achieve the above-described effects, it is not sufficient to simply reverse the direction of flow of the fluid. Rather, the insertion element 54 and the closing element 28 must receive the flow in the same manner. To this end, the valve seat 26 is modified in such a manner that the supply line 20 has a substantially cylindrical section 72 arranged inside the removal line 22 and communicates via a slot 74 with the rest of the supply line 20. In the example shown, the substantially cylindrical section 72 tapers down with an increasing distance from closing element 28. The fluid flows radially into the first housing part 12 and flows through the slot 74 in order to subsequently flow substantially parallel to the longitudinal axis L to the closing element 28 and to the insertion element 54. After the fluid has passed the throttle cross section A, it flows into the removal line 22 and substantially parallel to the longitudinal axis L through an annular chamber 76 which is formed by the cylindrical section 72 inside the supply line 22 and leaves the first housing part 14, also substantially parallel to the longitudinal axis L. Even in this exemplary embodiment the opening behavior is improved and the useful pressure pN is throttled less strongly than in traditional fluid-controlled valves.

### List of Reference Numerals

10 valve

11 housing

14 first housing part

16 second housing part

18 line system

20 supply line

22 removal line

24 valve body

26 valve seat

28 closing element

30 armature

32 return element

34 return spring

36 adjustment device

40 pole shoe

41 casing

42 coil body

44 conduit

46 pressure chamber

48 annular slot

50 bypass

52 means

54 insertion element

56 recess

58 spring

60 first leg

62 second leg

64 recess

66 bevel

68 slot

70 closing area

72 cylindrical section

74 slot

76 annular chamber

A throttle cross section

b distance front surface-closing area

pV supply pressure

pN useful pressure

pS closing pressure

L longitudinal axis

p distance armature casing

q distance closing element-insertion element

1. A valve for opening and closing a line system, comprising:
a valve body which forms a valve seat,
a line system with a supply line for supplying a fluid to the valve seat and a removal line for removing the fluid from the valve seat, wherein the fluid in the supply line stands under a supply pressure and in the removal line under a useful pressure,
a closing element which cooperates with the valve seat for opening and closing the line system, wherein the closing element frees a throttle cross section between the valve seat and the closing element,
a return element which applies a return force on the closing element and which presses the closing element against the valve seat for closing the line system,
a pressure chamber in which the fluid stands under a closing pressure with which the fluid applies a closing force on the closing element for closing the line system,
an insertion element with which the closing pressure in the pressure chamber can be lowered below the supply pressure as a function of the freed throttle cross section.

2. The valve according to claim 1, wherein the insertion element comprises a conduit which runs through the closing element and empties into the supply line, which conduit has a fluid communication with the pressure chamber.

3. The valve according to claim 2, further comprising a bypass which comprises the conduit and an annular slot surrounding the closing element and emptying into the removal line.

4. The valve according to claim 3, wherein the insertion element forms, together with the closing element, at least a part of the conduit in an area of the throttle cross section.

5. The valve according to claim 1, wherein the closing element comprises a cylindrical recess in which the insertion element is arranged.

6. The valve according to claim 5, wherein the insertion element has a U-shaped cross section with a first leg running substantially vertically to a longitudinal axis and a second leg running substantially parallel to the a longitudinal axis.

7. The valve according to claim 4, wherein the insertion element comprises a first front surface which faces the closing element and on which a number of recesses are arranged.

8. The valve according to claim 6, wherein the insertion element forms a second front surface on a free end of the second leg and which comprises a bevel facing the longitudinal axis.

9. The valve according to claim 4, wherein the insertion element can move relative to the closing element.

10. The valve according to claim 9, wherein the insertion element is fastened by a number of springs on the closing element.

11. The valve according to claim 1, wherein the valve comprises an adjustment device for moving the closing element along a longitudinal axis.

12. A vehicle, comprising a valve claim 1.

13. A method for operating a valve for opening and closing a line system, comprising:
providing a the valve, wherein the valve comprises:
a valve body which forms a valve seat,
a line system with a supply line for supplying a fluid to the valve seat and a removal line for removing the fluid from the valve seat, wherein the fluid in the supply line stands under a supply pressure and in the removal line under a useful pressure,
a closing element which cooperates with the valve seat for opening and closing the line system,
a return element which applies a return force on the closing element and which presses the closing element against the valve seat for closing the line system, and
a pressure chamber in which the fluid stands under a closing pressure with which the fluid applies a closing force on the closing element for closing the line system, and
freeing a throttle cross section between the valve seat and the closing element when the supply pressure exceeds a given threshold value, and
lowering the closing pressure in the pressure chamber below the supply pressure with an insertion element.
